(19) United States
(12) Patent Application Publication
(10) Pub. No.: US 2013/0269333 A1
(43) Pub. Date: Oct. 17, 2013

(54) FULL-WATER-COLUMN SURGE-TYPE WAVE-ENERGY CONVERTER

(71) Applicants: Arthur Robert Williams, Princeton, MA (US); Olivier Ceberio, Boston, MA (US)

(72) Inventors: Arthur Robert Williams, Princeton, MA (US); Olivier Ceberio, Boston, MA (US)

(21) Appl. No.: 13/880,669

(22) PCT Filed: Sep. 14, 2011
(86) PCT No.: PCT/US2011/051642

§ 371 Date: Jul. 8, 2013

Related U.S. Application Data
(60) Provisional application No. 61/405,287, filed on Oct. 21, 2010.

(51) Int. Cl. F03B 13/18

(52) U.S. Cl. CPC F03B 13/182
USPC 60/506

(57) ABSTRACT

A wave-energy converter (WEC) designed to capture the predominantly horizontal (surge) water motion in near-shore waves is called a Surge-type WEC. A Surge-type WEC comprises a moveable paddle that faces and resists the wave motion, in a way that converts the energy of the wave motion into a more useful form, such as electricity. The challenge addressed by the present invention is the efficient capture of the energy contained in the entire water column, from the seabed to the surface. This is a challenge because the height of the water column (depth) varies both within waves and with the tide. Capture of the full water column is accomplished using a floating paddle. The top of the paddle is pinned to the water surface by buoyancy. The lower portion of the water column is captured differently in different embodiments.

### TECHNICAL FIELD

In various embodiments, the invention relates to the capture and conversion of the energy carried by water waves, and more particularly to systems and methods for the capture and conversion of wave energy at depths where the local water motion comprising the waves is primarily horizontal (surge).

### BACKGROUND ART

Surge-type WECs are comprised of a paddle, a substantially planar surface, held in place and moved by a supporting structure so that the paddle faces and resists the oscillatory local water motion internal to waves propagating at (near) the surface of a body of water. The paddle resists the wave motion with a force that drives an electric generator or other means of consuming or storing the energy captured by (transferred to) the paddle. In this way the wave energy is converted to a more useful form, such as electricity. The local water motion internal to waves in relatively shallow water is predominantly horizontal and is called surge. A surge-type WEC is thus best suited to relatively shallow water.

The amplitude of the local motion of the water internal to waves decreases exponentially rapidly with depth. Nevertheless, in shallow water the motion extends to the seabed, making it desirable to capture the energy carried by the entire water column. This full-water-column objective creates a challenge, because the height of the full water column, the depth, is not constant. The depth varies on a variety of time scales, including the wave period, the tide, with changing weather conditions and with the season. Previous Surge-type WEC development has attempted to capture the relatively slow depth variations due to tide, weather and season. The present invention efficiently captures the energy carried by the full water column including the more rapid intra-wave depth variations.

### DESCRIPTION OF RELATED ART

International patent application WO9817911 (Lombardo), U.S. patents 2006150626 (Koivusaari) and 2008191485 (Whittaker) and U.S. patent application 2010111609 (Espedal) discuss surge-type wave-energy-conversion devices characterized schematically in FIG. 1. All comprise fixed-height paddles [2] that are hinge mounted [3] to the seabed and hydraulic power-takeoff (PTO) [4,8] subsystems. All transmit the captured wave power [9] in the form of a pressurized fluid. Note that the some of the elements in FIG. 1 extend into the plane of the figure, while others do not. The paddle [2] and hinge axis extend into the diagram, while the PTO elements [4, 8 and 9] do not. The hinge [3] can possess either character.

U.S. Pat. No. 4,208,877 (Davis) describes a WEC system comprising a floating cylinder. U.S. patent 2008191485 describes a system in which the hinge [3] and its axis of motion [6] can be raised and lowered in order to track tidal motion.

International patent application WO 2011079199 (Goudey) describes a seabed-hinged surge-type WEC paddle that extends to stabilize the power conversion.

### BRIEF SUMMARY OF THE INVENTION

The energy in the entire fluctuating water column is captured by a surge-type WEC comprising a floating paddle thereby ensuring the capture of the most energy-dense, near-surface portion of the water column, even as the water depth changes. The wave-driven local water motion in the lower portion of the water column is captured differently in different embodiments of the invention. The preferred embodiment synthesizes a paddle attached to a floating buoy and a second paddle hinge mounted to the base, where the base can be the seabed or a platform floating at a depth at which the wave-driven local water motion is negligible. The embodiments considered all exploit structures requiring primarily tensile strength. In particular, cables are pervasively used.

### BRIEF DESCRIPTION OF THE DRAWINGS

FIG. 1 is a schematic side view of a conventional surge-type WEC showing the relationships and connections among its functional components.

FIG. 2a is a schematic side view of a surge-type WEC wherein the hydraulic subsystem of FIG. 1 is replaced by cables and drums.

FIG. 2b is a schematic frontal view of the cable-based surge-type WEC shown schematically in FIG. 2a.

FIG. 3 shows a schematic side view of a floating-paddle surge-type WEC comprising a paddle comprised of buoy and keel portions and moored by sets of three-cables, two capturing surge motion and one vertical cable capturing the vertical heave motion of the floating paddle.

FIG. 4 shows a schematic side view of a floating-paddle surge-type WEC in which the keel portion of the floating paddle comprises panel segments connected by hinges.

FIG. 5 shows a schematic side view of the paddle, cable and PTO drum components of a floating-paddle surge-type WEC illustrating the use of pulleys to consolidate the cables into a single PTO.

FIG. 6 shows a schematic side view of a surge-type WEC in which cable drums of different diameters are used to create nonplanar motion of the paddle.

FIG. 7a shows a schematic side view of a floating-paddle surge-type WEC in which full-water-column coverage is achieved by rigid deflection plates.

FIG. 7b shows a schematic frontal view of the floating-paddle surge-type WEC shown in FIG. 7a showing the relative locations of the cables and the deflection plates.

FIG. 8 shows a schematic side view of a floating-paddle surge-type WEC in which full-water-column coverage is achieved by hinged deflection plates that “ride” the keel portion of the floating paddle.

FIG. 9 shows a schematic side view of a floating-paddle surge-type WEC that achieves full-water-column coverage by means of a split keel wherein the magnitude of the “split” varies with the water depth.

FIG. 10 shows a schematic side view of a floating-paddle surge-type WEC that achieves full-water-column coverage by means of a split fabric keel wherein the magnitude of the “split” is controlled by the diameters of the PTO drums on which the cables wind.

FIG. 11 shows a schematic side view of a floating-paddle surge-type WEC in which full-water-column coverage is achieved by bending the flexible keel portion of the floating paddle around a seabed mounted roller.

FIG. 12a is a schematic side view of a surge-type WEC in which full-water-column coverage is achieved by overlapping two paddle components, one pinned to the surface, the other to the seabed.

FIG. 12b shows a schematic side view of the surge-type WEC shown in Fi

FIG. 12c shows a schematic frontal view of one side of the surge-type WEC shown in FIGS. 12a and 12b.

FIG. 13a shows a schematic side view of a floating-paddle surge-type WEC in which full-water-column coverage is accomplished using overlapping paddles, one paddle pinned to the water surface, the other pinned to the seabed.

FIG. 13b shows a schematic frontal view of a floating-paddle surge-type WEC shown in FIG. 13a.

FIG. 14 shows a schematic side view of a floating-paddle surge-type WEC comprising buoy-mounted hinged deflector plates and a seabed-hinged paddle.

### OBJECTS OF THE INVENTION

In various embodiments, the invention achieves the following objectives:

Wave energy capture of water motion in the entire water column when the depth of the water column varies due both to tidal and wave action.

The exploitation of tension carrying cables and flexible fabrics to reduce costs.

The consolidation of mooring cables to aggregate captured wave power and minimize PTO cost.

The exploitation of cable winding hubs of different diameters to optimize surge-type WEC paddle motion and shape.

### DETAILED DESCRIPTION OF THE INVENTION

We now describe in greater detail both the challenge addressed by the present invention as well as the invention itself.

We recall from the summary above that our objective is to capture and convert the energy manifest in the local water motion caused by wave motion near the surface of a body of water. Near shore, where we can benefit from the relative constancy of the wave direction, the local water motion extends all the way to the sea bed. In order to capture as large a fraction of the wave energy as possible, we want to harness the local water motion over the entire water column, from the surface to the seabed.

We are led in this way to surge-type WECs in which the paddle by which we harness the local water motion floats. Providing sufficient buoyancy to keep the top edge of the paddle above the water surface in anticipated sea states delivers the double benefit of enabling the capture of vertical heave component of the local water motion as well as the surge motion, which is the usual target of surge-type WEC technology. We call the upper portion of the paddle providing the desired buoyancy the buoy portion.

The desire to capture the local water motion not only at the surface, but below the surface as well leads to the extension of the paddle downward toward the seabed. A fundamental challenge addressed by this invention is coverage of the full water column when the height of the column, the depth of the water, is varying due to both tides and the wave action itself.

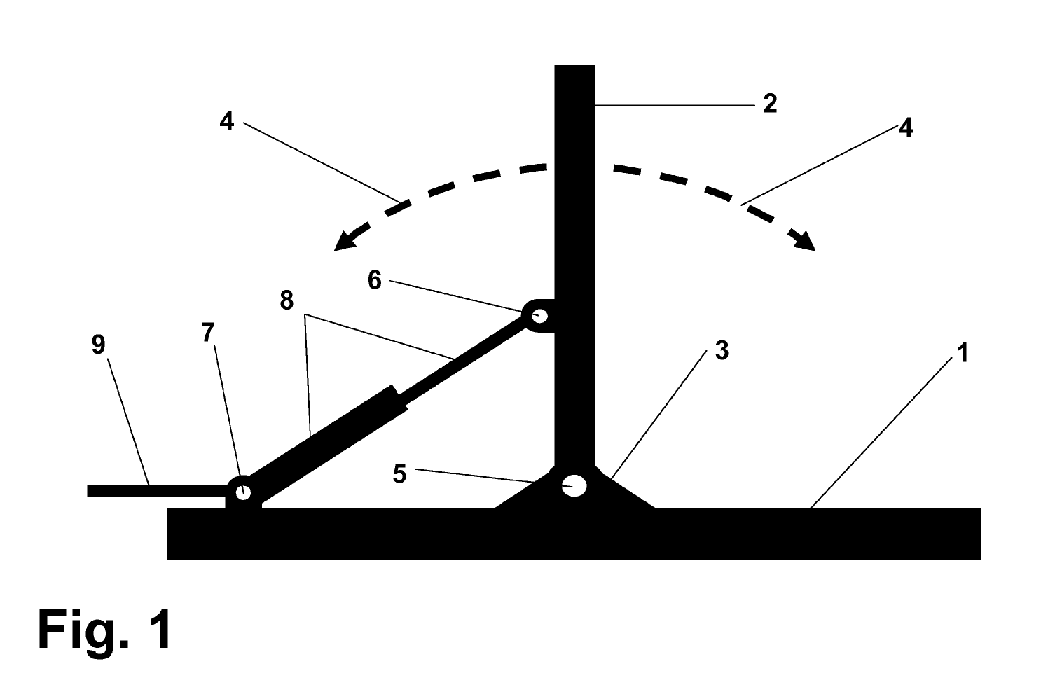

To capture the energy in the subsurface water motion we extend the paddle downward from the buoy portion of the paddle much as a keel extends downward from the bottom of a boat. This keel plays the role played by the entire paddle [2] in a conventional surge-type WEC such as that illustrated in FIG. 1. But, depth variation of the water column creates the potential of our keel running aground.

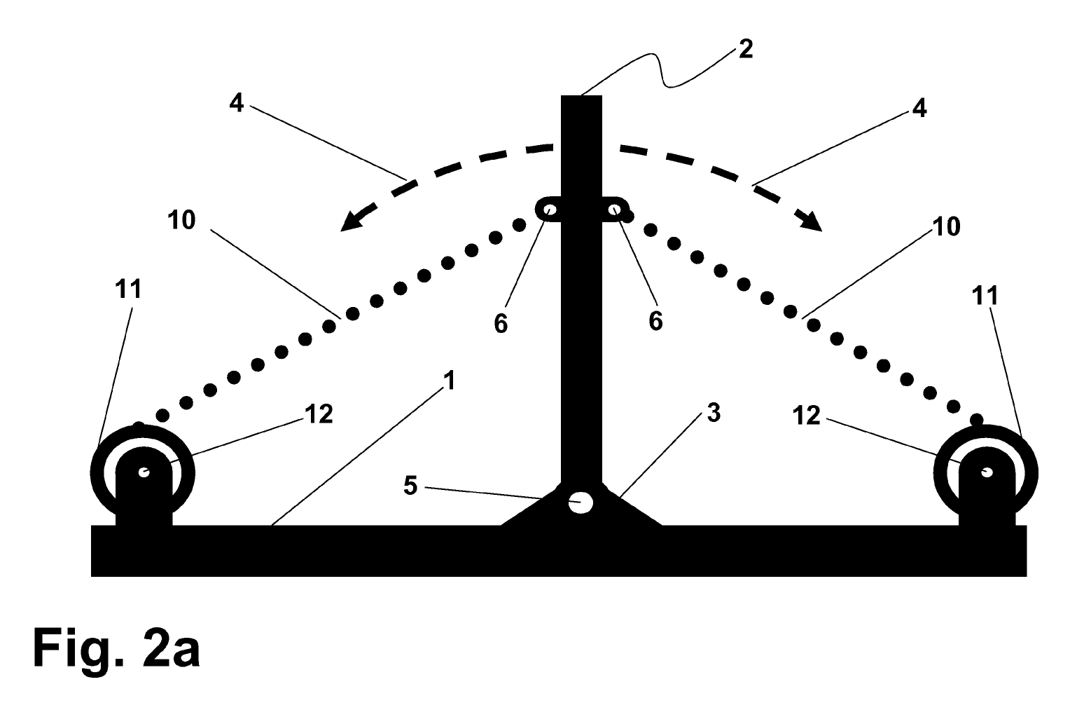

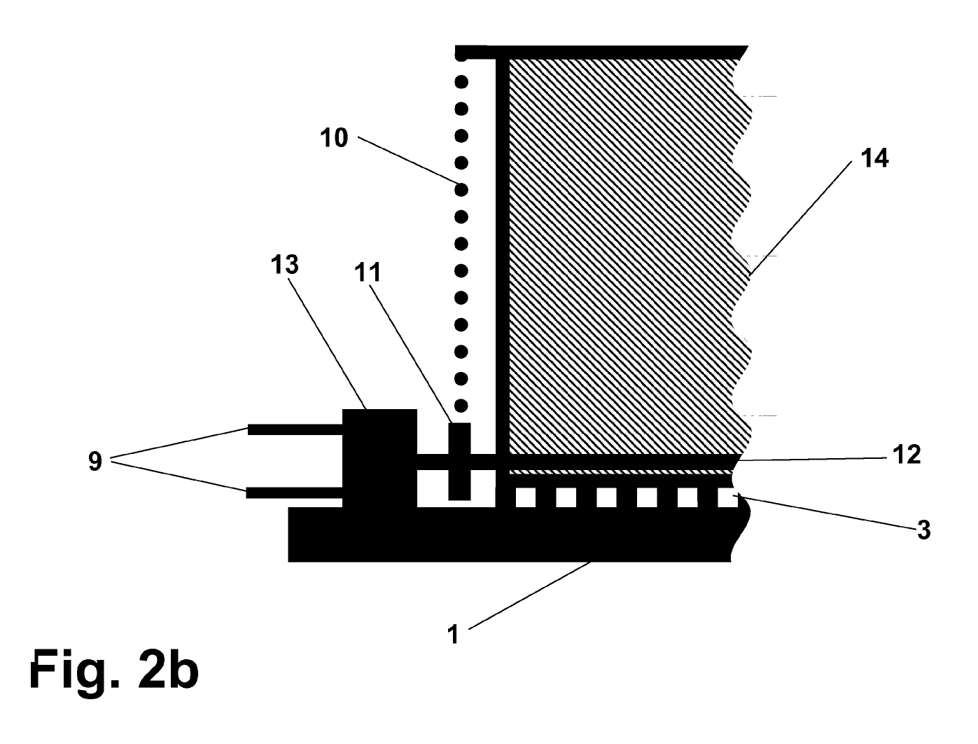

We consider three approaches to this challenge. All three involve the introduction of cable-based PTO systems. The simple replacement of the hydraulic PTO [8] shown in FIG. 1 by the analogous cable-based [9, 10, 11, 12, 13 ] illustrated in FIGS. 2a and 2b. One end of each cable is attached to the paddle [6], while the other end is wrapped around a drum [11] mounted to an axel [12]. When the paddle moves [4] one of the two drums [11] in FIG. 2a unwinds turning the axel [12] while the other drum is biased to remove slack from the cable. The attachment of the drum [11] to the axel [12] is a one-way clutch, which might be centrifugal, or ratcheted, e.g.

FIG. 2b shows how the cables [10], the drum [11], the axel [12] and the hinge [3] are configured. Also shown in FIG. 2b is the attachment of a power converter [13] to the axel [12] turned by the cable [10]. The power converter can be an electric generator, in which case the power conduits [9] are conducting wires, or a fluid pump, in which case the conduits [9] carry a fluid pressurized by the power converter [13].

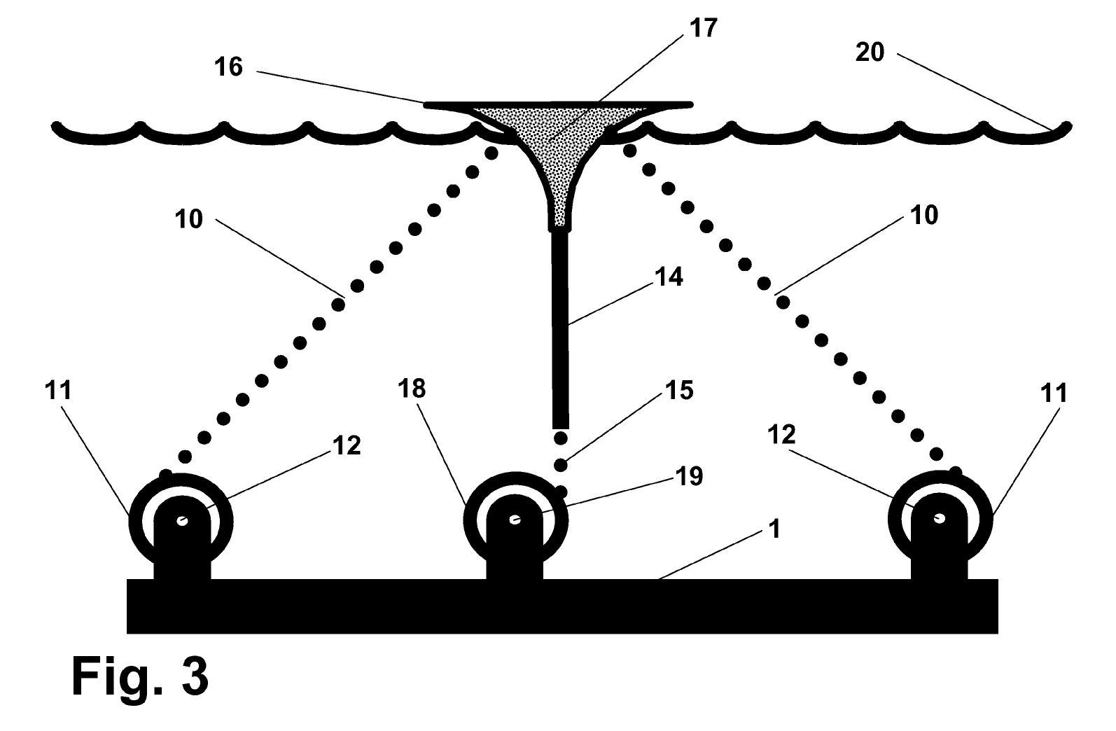

We consider three approaches, and we discuss them in turn. All three approaches utilize a floating paddle, like that illustrated in FIG. 3. The paddle comprises two portions; the top of the paddle is a highly buoyant, buoy-like portion [16, 17] sufficiently buoyant to keep the top of the paddle above the surface of the water in all anticipated sea states and PTO loadings. The required buoyancy is provided by the interior of the paddle top [17] enclosed in a protective housing [16]. The lower portion of the paddle [14] is attached to the buoy-like upper portion [16, 17], and extends downward toward the seabed. Note that, as with FIGS. 1 and 2, some elements of FIG. 3 extend into the plane of the diagram, while others do not. The floating paddle [14, 16, 17], as well as the water [20] and the seabed [1] extend into the plane of the diagram, while the PTO subsystems, [10, 11, 12] and [15. 18, 19] do not; they may be repeated as required, but they are discrete.

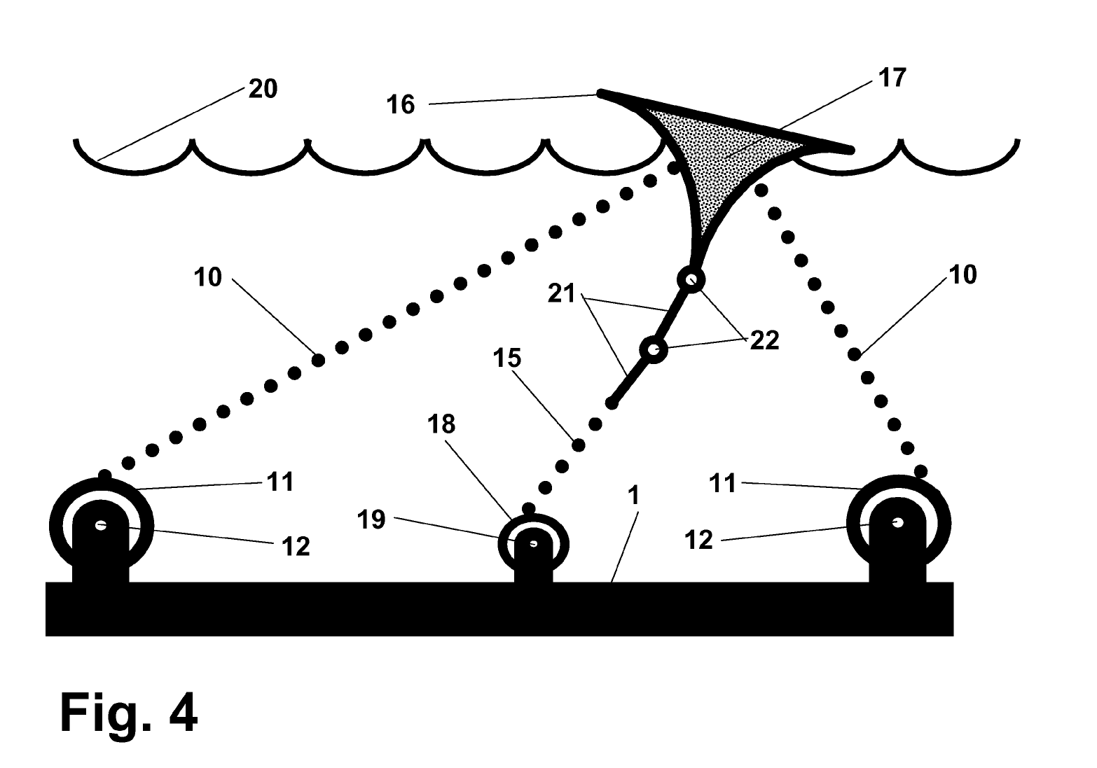

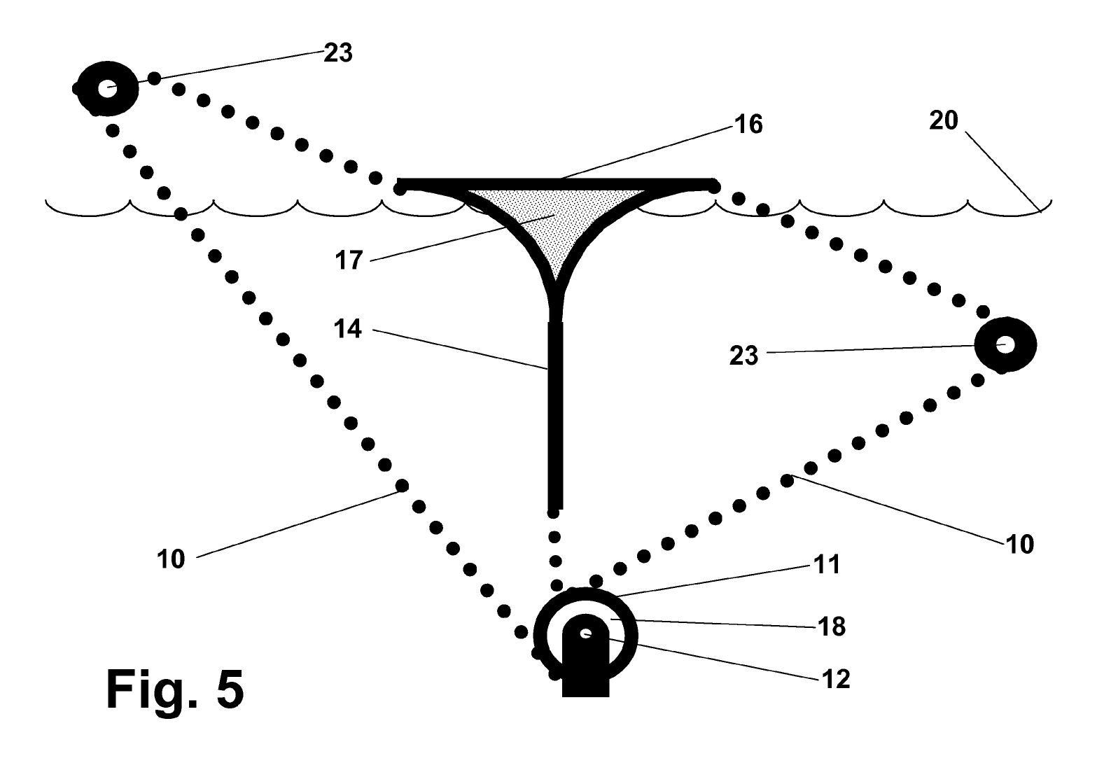

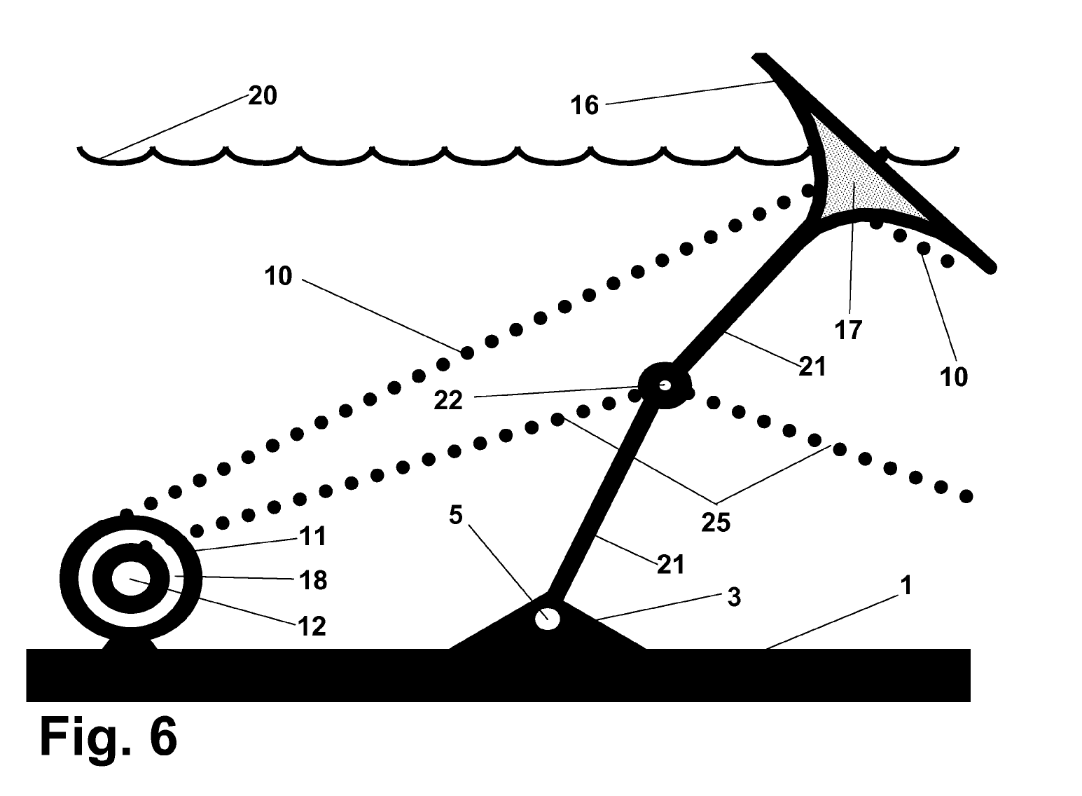

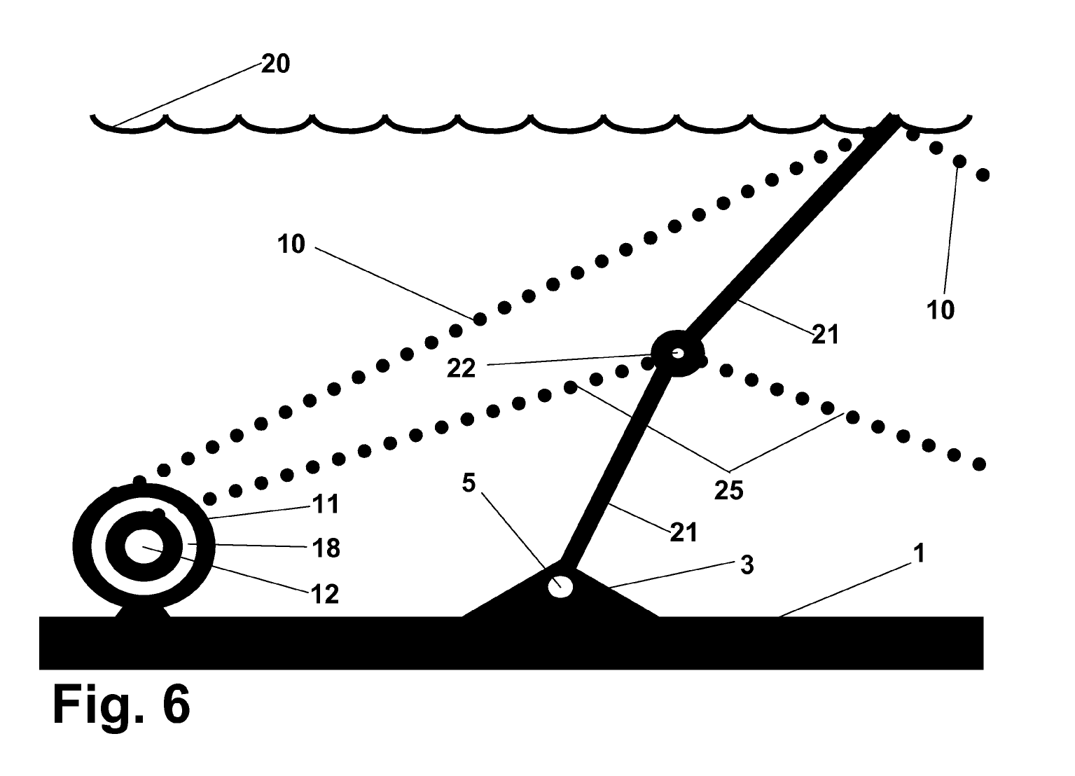

Among the virtues of the floating paddle illustrated in FIG. 3 is that most of the structural strength require is tensile, which is often significantly lighter and less expensive than other forms of structural strength. A related virtue of the keel-like portion of the paddle requiring only tensile strength is the fact that it can be flexible. The keel-like portion of the paddle can be a fabric, such as that used as industrial conveyor belts or automobile tires, or the keel portion of the paddle can comprise panel segments [21] connected together by hinges [22], as illustrated in FIG. 4. Another virtue illustrated in FIG. 4 is that the diameter of the drums on which the cables are wound is a design option. When the drums on which different cables are wound [11,18] are mounted on the same axel [18], as illustrated in FIG. 5, the shape of the paddle surface presented to the wave motion can be engineered and optimized. FIG. 6 illustrates a dynamically varying paddle profile, with the nonplanarity controlled by the ratio of the diameters of the drums [11, 18].

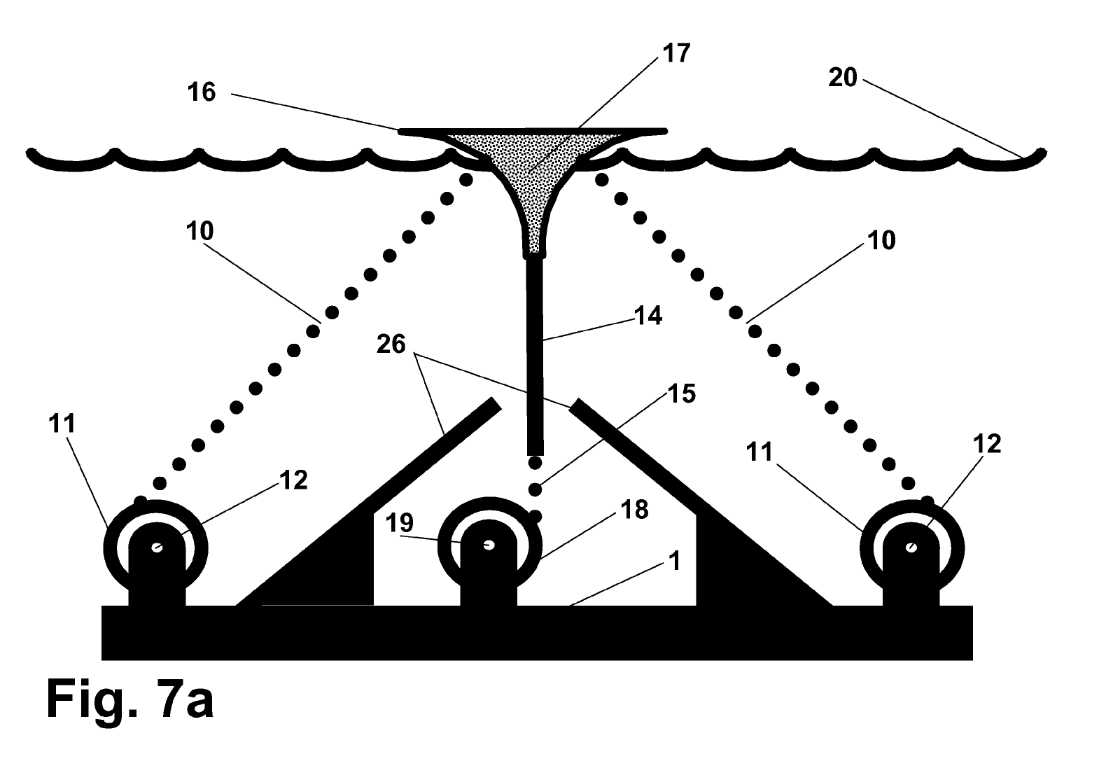

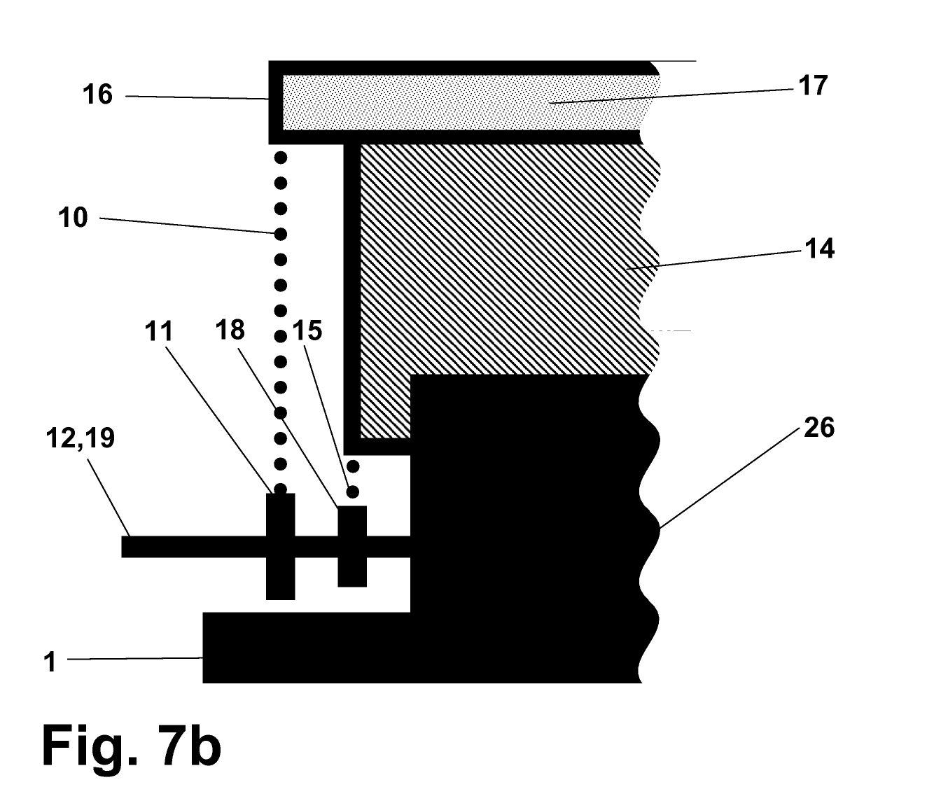

We turn now to the challenge of covering the full water column when the height of the column varies. Note that the depth variation takes place on two rather different time scales, the period of the waves and that of the tide. FIG. 7 illustrates what is perhaps the most straightforward approach, adding deflection plates to a system like that illustrated in FIG. 3. The result is shown in FIGS. 7a and 7b. Deflection plates [26] extend into the plane of the diagram, and serve to deflect water approaching the paddle near the seabed to the paddle [14, 16, 18]. FIG. 7b shows that the plates, cables, axels and drums indicated in FIG. 7a need not interfere with one another.

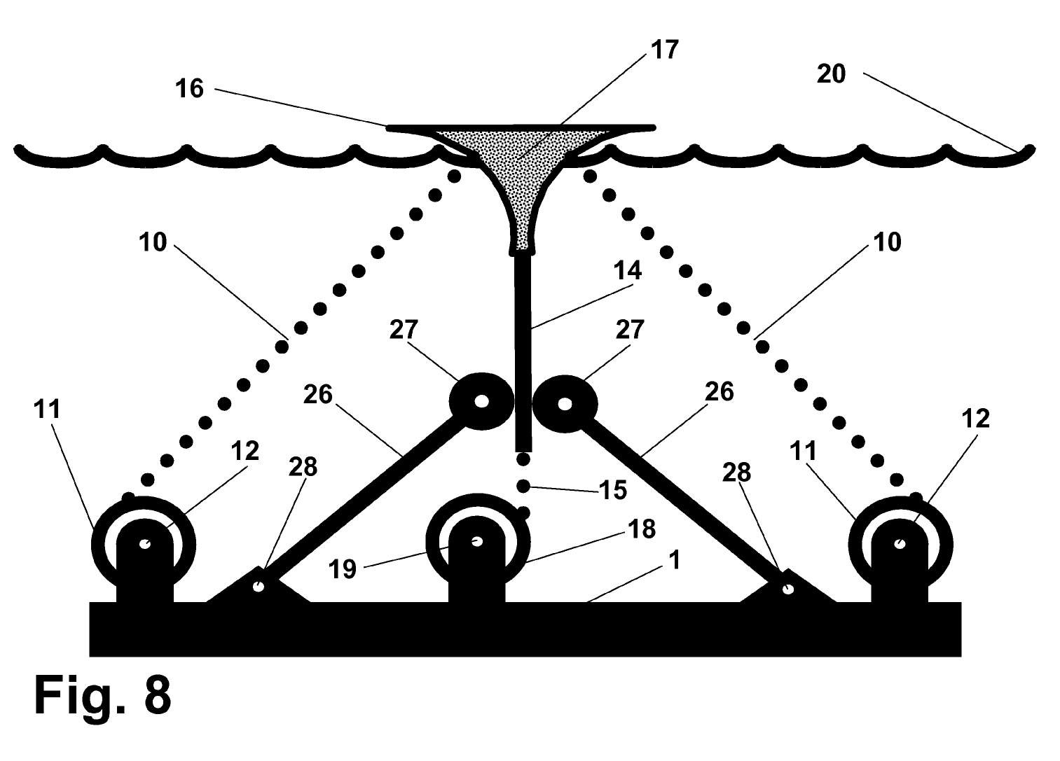

FIG. 8 shows a variation on the theme introduced in FIG. 7. FIG. 8 again shows deflection plates again playing the same role played in FIG. 7. The difference is that in FIG. 8, the deflection plates are not fixed. Rather, they are hinge attached to the base, allowing the deflection plates to follow the horizontal motion of the keel portion [14] of the floating paddle, maintaining a small gap between the top edge of the deflection plate [26] and the keel portion [14] of the floating paddle. Maintenance of this small separation if facilitated by wheels [27] attached to the top of the deflection plate [26] that permit the plate to maintain its proximity to the keel [14] while not significantly inhibiting its motion. An additional assist to the maintenance of the proximity of plate [26] and keel [14] may be provided by a biasing force that presses the plate [26] against the keel [14]. The biasing force may be provided by a spring in the hinge [28] or a spring connecting the plate [26] to the base [1]. Note that the wave-driven local water motion naturally plays the same role.

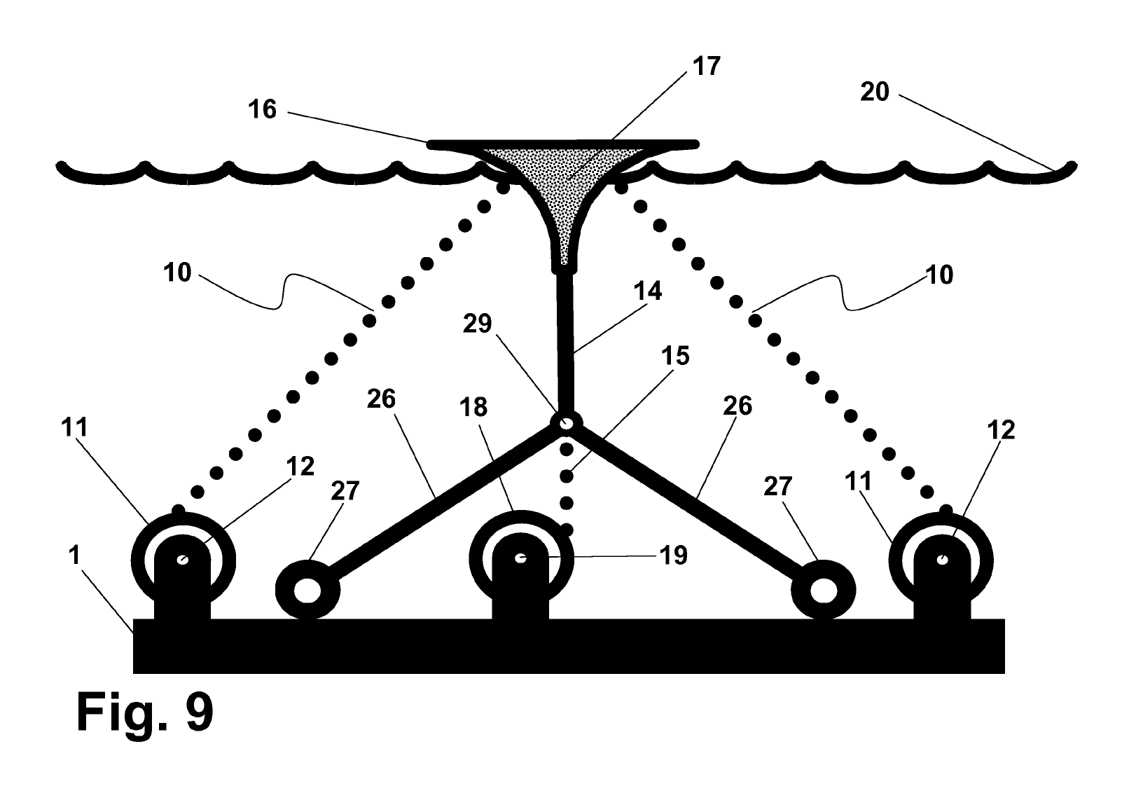

FIG. 9 illustrates a different, but similar, configuration. Here the locations of the hinge and wheel in FIG. 8 are reversed. This eliminates the separation between the plate [26] and the

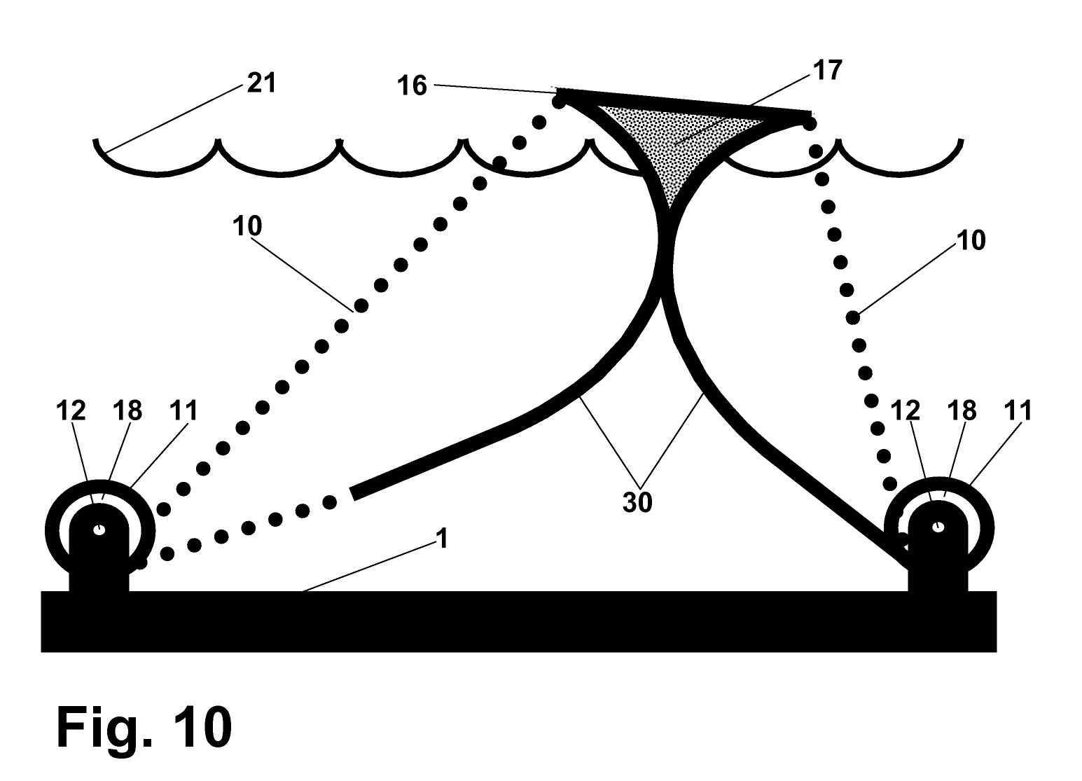

FIG. 10 shows a related configuration, this one exploiting the fact that the keel portion [14] of the floating paddle may comprise a flexible fabric. In FIG. 10, the keel comprises two flexible sheets [30] that drape in the two directions away from the paddle. That is, one sheet drapes in the direction of wave propagation while the other sheet drapes in the opposite direction. FIG. 10 also illustrates the exploitation of multiple PTO cable drums [11] and [18] mounted to a common axel [12]. The diameters of the two drums [11,18] are independent, representing a design option. The ratio of the two diameters controls the rotation of the buoy portion [16, 17] of the floating paddle as it oscillates with the wave action. Note that while the configuration shown in FIG. 10 increases the number of required cables relative to the configurations shown in FIGS. 3, 4, 5, 7, 8 and 9, it reduces the number of required axels. Note also that freedom to choose the rotation direction of the axels [12] renders the separation of the draped keel [20] from the base [1] to be independent of the diameters of the PTO drums [11] and [18].

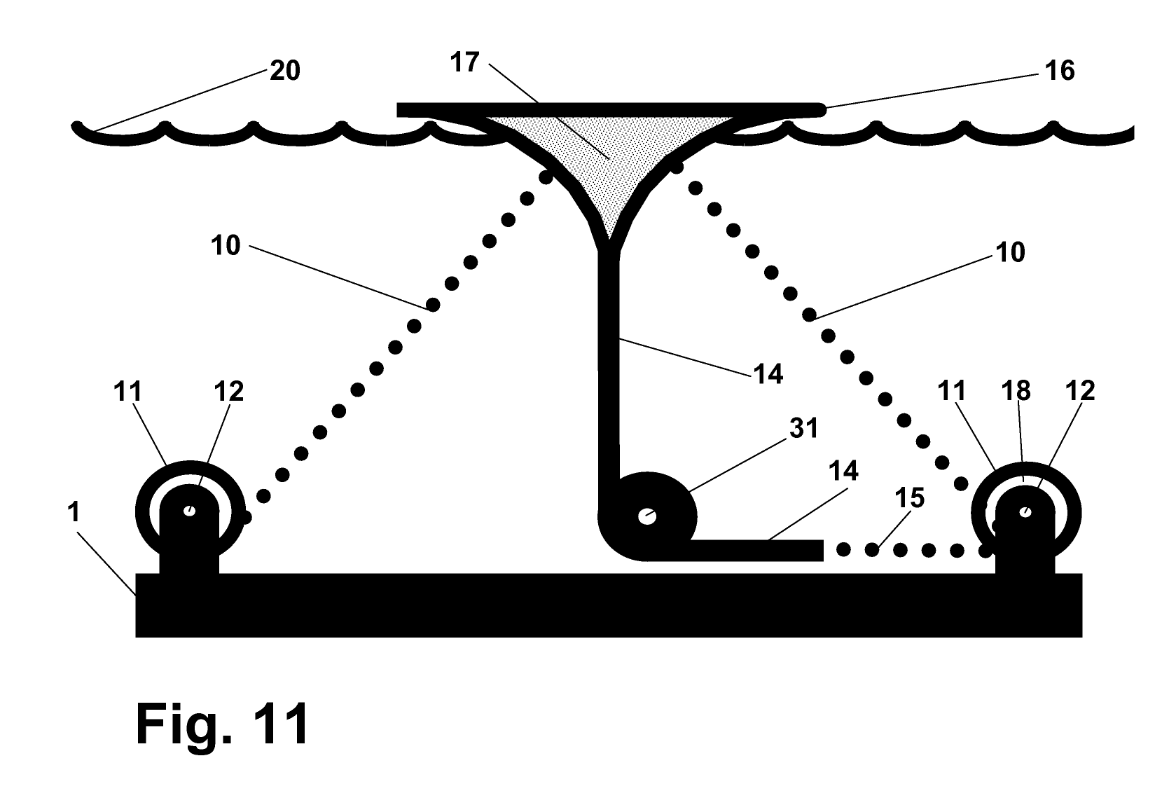

FIG. 11 shows another way in which flexibility of the keel may be exploited. Here the keel [14] moves around a roller [31] mounted to the base [1], allowing the keel [14] to cover almost all of the water column. Note that the roller [31] extends across the keel [14] (into the plane of the diagram). The flexible keel [14] may also be wound around the roller [31], in which case the axel of the roller [31] may drive a power-conversion device [13]. With a modest increase in configurational complication the roller [31] required by either the “window-shade” configuration of the “single-bend’ configuration can be mounted in the buoy portion [16, 17] of the floating paddle thereby reducing the need for underwater servicing and maintenance.

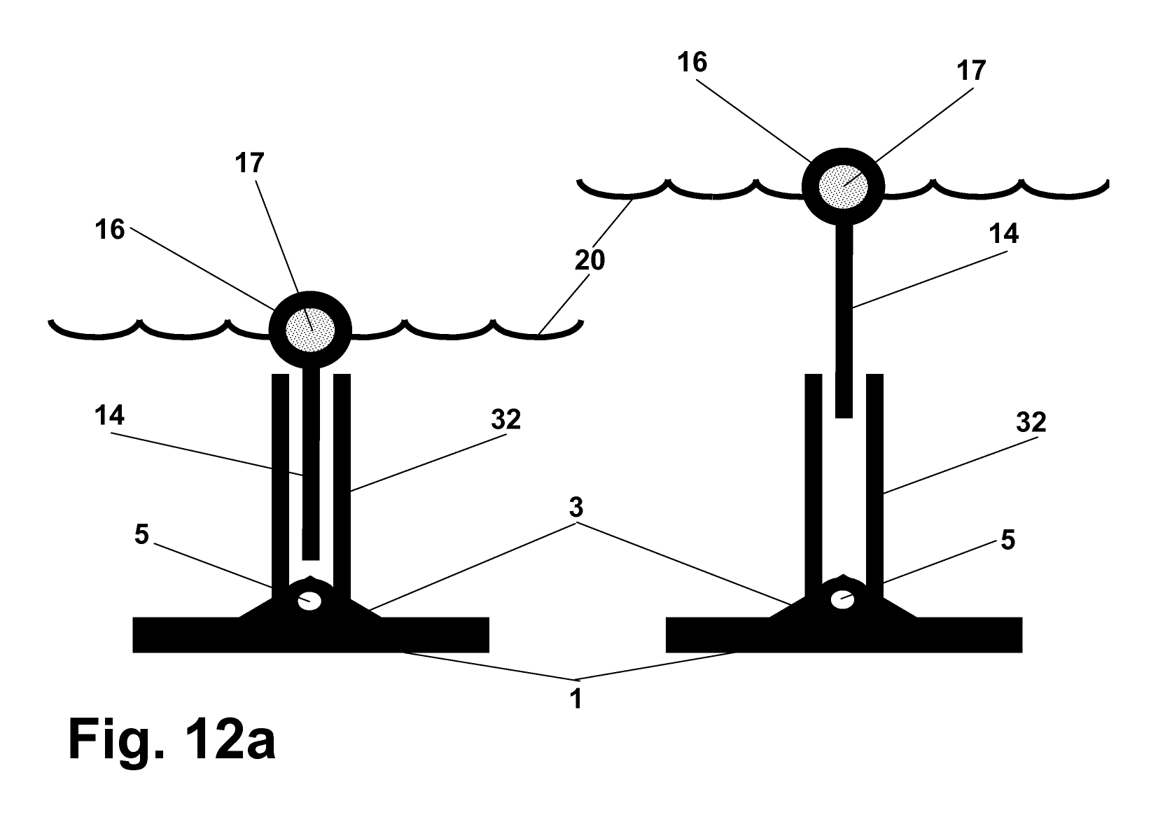

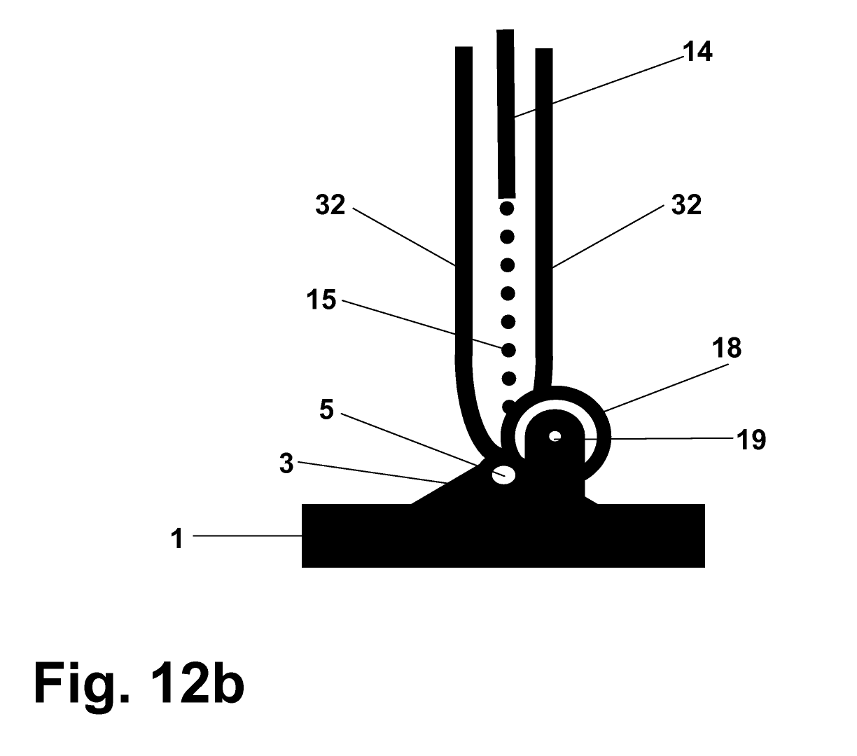

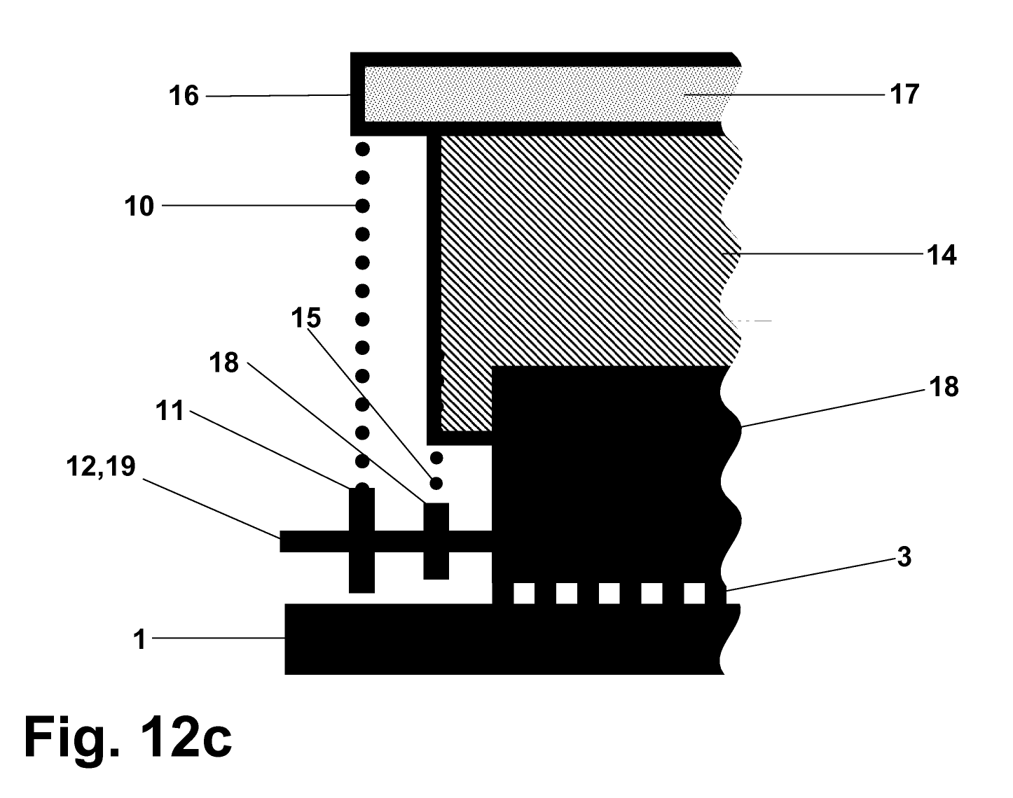

FIG. 12 shows another way in which the full water column may be captured. Here, the upper portion of the water column is again covered by a floating paddle comprising buoy [16, 17] and keel [14] portions. The configuration shown in FIG. 12 differs from those discussed above in covering the lower portion of the water column with a second paddle that is hinge attached to the base [1], that is, similar to the hinge-attached paddle shown in FIGS. 1 and 2. The lower, hinge-attached paddle [32] comprises two substantially rectangular sheets between which the keel [14] of the upper paddle slides, as shown in FIG. 12a. FIGS. 12b and 12c show that the configuration shown in FIG. 12a does not imply unusually complex mounting and cabling complexity.

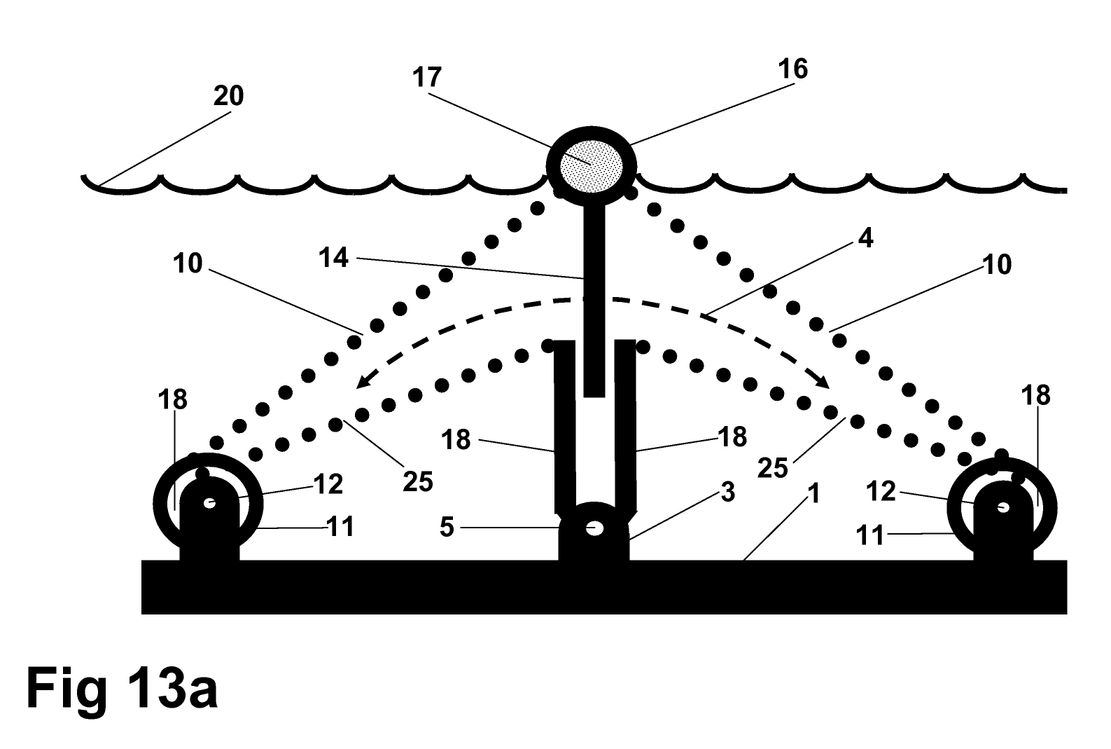

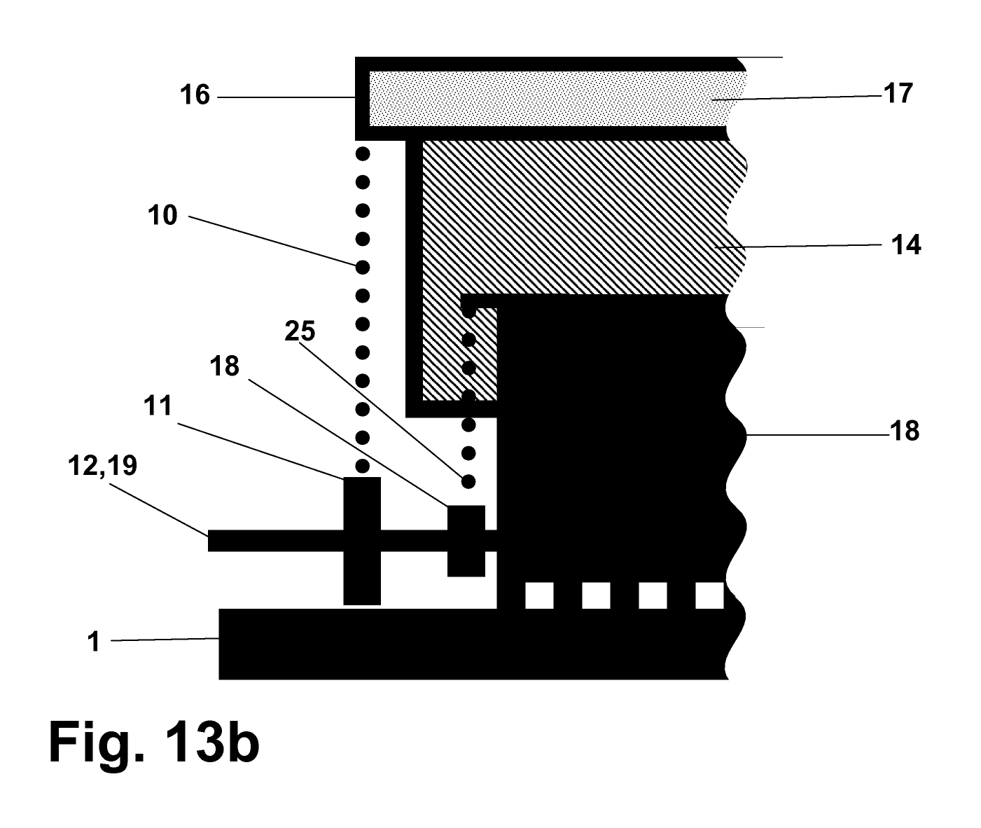

FIG. 13 shows a cabling option for the system shown in FIG. 12. Like the configuration shown in FIG. 10, the configuration shown in FIG. 13 increases the number of cables, while reducing the number of PTO axels. As with the configuration shown in FIG. 10, multiple cable drums [11, 18] are mounted to a common PTO axel [12], and the diameters of the cable drums [11, 18] control the extent to which the keel [14] remains vertical as the paddle oscillates.

### Best Mode

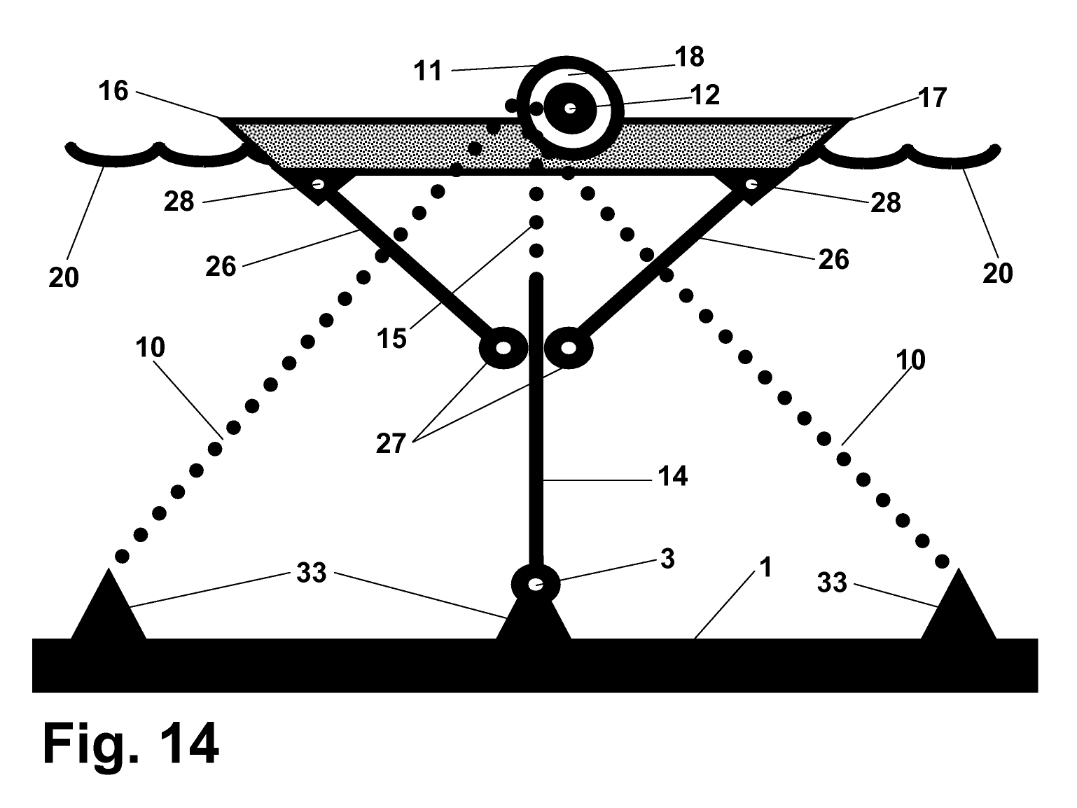

Our preferred embodiment utilizes many of the design elements discussed above. It can be thought of as the configuration shown in FIG. 8 turned upside down. A highly buoyant buoy-like element pins the surge-type WEC to the water surface. Unlike the configuration shown in FIG. 8, however, the keel-like element [14] is hinge-attached to the base [3]. As in FIG. 8 deflector plates ride the keel [27], but in FIG. 14 these deflector plates are hinge-attached [28] to the buoy-like element [16, 17]. The two wheels [27] mounted on the lower edge of the deflector plates are biased by springs to maintain contact with the keel [14], even if the keel moves horizontally. As in FIG. 8, the deflector plates act to prevent water from bypassing the paddle, but in FIG. 14 it is water near the top of the water column on which they act. As in FIG. 5, all of the required cables act on drums mounted to a single, common PTO axel [12]. Note that, because the axel extends into the plane of FIG. 14, the axel [12] must be above the top of the buoy [16, 17].

The special advantage of the configuration shown in FIG. 14 is that all system elements of significant complexity and cost are located at the water surface, where installation and maintenance are significantly less expensive. The permanently submerged elements of the system are the massive, but simple moorings [33]

1. A wave-energy-conversion (WEC) device comprising:
a substantially rectangular paddle positioned to expose its two faces to the local water motion caused by wave action near the surface of a body of water, wherein
said paddle oscillates in response to variations in the net pressure on said paddle caused by said wave action wherein
the amplitude of said oscillation is reduced, relative to the amplitude of said local water motion in the absence of said paddle, by a force exerted on said paddle by a power-takeoff (PTO) subsystem, wherein
said force is transmitted from said PTO to said paddle by at least one cable wherein
one end of said cable is attached to said paddle, and the other end of said cable is wound around a drum wherein
said drum is mounted to an axel to which a power-generation device is also mounted, and
a conduit capable of carrying said power in a convenient form to a destination.

2. A wave-energy-conversion (WEC) device as in claim 1 wherein
said paddle is hinge mounted to a base wherein
said base is substantially stationary relative to said wave-driven local-water motion.

3. A wave-energy-conversion (WEC) device as in claim 2 wherein
said base is the seabed.

4. A wave-energy-conversion (WEC) device as in claim 2 wherein
said base is a platform submerged below the surface of said body of water at a depth at which said wave-driven local water motion is negligible.

5. A wave-energy-conversion (WEC) device as in claim 1 wherein
said paddle comprises a strongly buoyant buoy-like upper portion from which an attached, substantially rectangular keel-like lower portion extends toward the seabed, wherein
said buoy-like paddle portion is sufficiently buoyant to keep the top edge of said paddle above the surface of said body of water under anticipated sea states and PTO loadings.

6. A wave-energy-conversion (WEC) device as in claim 5 additionally comprising at least one plate statically mounted to said base wherein
said plate directs said local-water motion near the seabed toward said keel-like paddle portion.

7. A wave-energy-conversion (WEC) device as in claim 5 additionally comprising at least one plate wherein
the lower edge of said plate is hinge mounted to said base and wherein
the upper edge of said plate is equipped with wheels that allow said keel-like paddle portion to move relative said plate while maintaining a small separation between said keel-like paddle portion and said plate.

8. A wave-energy-conversion (WEC) device as in claim 7 wherein
Said small separation between said keel-like paddle portion and said plate is maintained by a force applied to said plate.

9. A wave-energy-conversion (WEC) device as in claim 5 additionally comprising at least one plate wherein
the upper edge of said plate is hinge mounted to said keel-like paddle portion and wherein
the lower edge of said plate is equipped with wheels that allow said plate to move relative said base while maintaining a small separation between said plate and said base.

10. A wave-energy-conversion (WEC) device as in claim 5 wherein
said keel-like paddle portion comprises two substantially rectangular sheets of flexible fabric wherein
one said fabric sheet drapes away from said buoy-like paddle portion in the direction of anticipated wave propagation, and wherein
one said fabric sheet drapes away from said buoy-like paddle portion in the direction opposite that of anticipated wave propagation

11. A wave-energy-conversion (WEC) device as in claim 5 wherein
said keel-like paddle portion comprises a substantially rectangular sheet of flexible fabric that passes over a roller wherein
said roller enables substantially vertical motion of said fabric keel between said roller and said buoy-like paddle portion and substantially horizontal motion of said fabric keel between said roller and said PTO axel.

12. A wave-energy-conversion (WEC) device as in claim 11 wherein
said roller is mounted to said base.

13. A wave-energy-conversion (WEC) device as in claim 11 wherein
said roller is mounted to said buoy-like paddle portion.

14. A wave-energy-conversion (WEC) device as in claim 5 wherein
said keel-like paddle portion comprises a substantially rectangular sheet of flexible fabric that winds helically around a roller wherein
said roller enables substantially vertical motion of said fabric keel between said roller and said buoy-like paddle portion and wherein rotation of said roller powers a PTO.

15. A wave-energy-conversion (WEC) device as in claim 14 wherein
said roller is mounted to said base.

16. A wave-energy-conversion (WEC) device as in claim 14 wherein
said roller is mounted to said buoy paddle portion.

17. A wave-energy-conversion (WEC) device as in claim 5 wherein
said paddle comprises two portions, an upper portion pinned by buoyancy to the surface of said water and a lower portion that is hinge mounted to said base, wherein
said upper portion comprises buoy and keel portions wherein
said buoy portion is sufficiently buoyant to keep the top of said upper paddle portion above the surface of said water and wherein
said keel-like portion of said upper paddle portion is attached to said buoy portion of said upper paddle portion and wherein
said keel-like portion of said upper paddle portion extends toward the seabed and wherein
said keel-like portion of said upper paddle overlaps said lower paddle portion wherein
the degree of overlap varies with the depth of said body of water so as to cover the entire water column as the depth of said water column varies.

18. A wave-energy-conversion (WEC) device as in claim 17 wherein
the lower edge of said upper-paddle portion is moored by a cable to a a drum mounted to an axel wherein said axel is mounted to said base.

19. A wave-energy-conversion (WEC) device as in claim 17 wherein
the upper edges of said lower paddle portion are moored by cables to drums mounted on axel wherein
said axels are mounted to said base.

20. A wave-energy-conversion (WEC) device as in claim 5 wherein
said floating paddle is controllably submerged in dangerously violent weather, wherein
said submersion is controlled by a controlled increase in the tension in said mooring cables.

21. A wave-energy-conversion (WEC) device as in claim 5 wherein
said floating paddle is controllably submerged in dangerously violent weather, wherein
said submersion is controlled by a controlled decrease in the buoyancy of said buoy-like portion of said paddle.

22. A wave-energy-conversion (WEC) device as in claim 5 wherein
said keel-like paddle portion is flexible, thereby enabling a nonplanar response of said keel-like paddle portion to the pressure forces on the interior of said keel-like paddle portion and the opposing forces on said floating paddle due to said PTO.

23. A wave-energy-conversion (WEC) device as in claim 22 wherein
said flexible keel-like paddle portion is comprised of a fabric.

24. A wave-energy-conversion (WEC) device as in claim 22 wherein
said flexible keel-like paddle portion is comprised of hinge-connected substantially horizontal panels.

25. A wave-energy-conversion (WEC) device as in claim 22 wherein
at least one additional cable couples the interior of said keel-like paddle portion to a PTO, thereby providing additional control of the dynamical shape of said keel-like paddle portion as said paddle oscillates.

26. A wave-energy-conversion (WEC) device as in claim 25 wherein
one end of said additional cable wraps around a drum mounted to the same axel to which at least one other paddle-attached cable is drum mounted, wherein the diameters of said drums differ, enabling control of said dynamical paddle shape by choice of diameter ratio.

27. A wave-energy-conversion (WEC) device as in claim 1 wherein
the lower edge of said substantially rectangular paddle is hinge mounted to an underwater base wherein
said base is substantially stationary relative to said wave action and wherein
the upper edge of said paddle is attached by at least one cable to a drum mounted to an axel wherein
said axel is mounted to a highly buoyant floating platform wherein
a power-generation device is mounted to said axel, and wherein
at least two additional substantially orthogonal cables wind around additional drums also mounted to said axel wherein
said additional cables extend diagonally downward, and attach to said base and wherein
the upper edge of at least one deflection plate is hinge mounted to the underside of said buoyant platform and wherein
said hinge-mounted deflection plate is biased so that its lower edge maintains contact with said paddle through at least one wheel attached to the lower edge of said deflection plate and wherein
said paddle, platform, axel and deflection plate are all substantially parallel, and extend parallel to said base and perpendicular to the anticipated direction of wave propagation.

28. A wave-energy-conversion (WEC) device as in claim 1 wherein
the direction of motion of at least one of said cables is altered by passage over a pulley.

29. A wave-energy-conversion (WEC) device as in claim 28 wherein
the direction of motion of said cable passing over said pulley maximizes the power transmitted by said cable to said PTO.

30. A wave-energy-conversion (WEC) device as in claim 28 wherein
said cable redirection allows multiple said cables to be mounted to a common axel.

31. A wave-energy-conversion (WEC) device as in claim 30 herein
said common axel drives an electric generator.

32. A wave-energy-conversion (WEC) device as in claim 30 wherein
said common axel drives a fluid pump.
